(19) United States
(12) Patent Application Publication
(10) Pub. No.: US 2016/0070871 A1
(43) Pub. Date: Mar. 10, 2016

(54) SYSTEM AND METHOD FOR RECOMMENDING OPTIMUM INSULIN BOLUS DOSAGE

(71) Applicant: Quattro Folia Oy, Espoo (FI)

(72) Inventors: Pekka Heinonen, Espoo (FI); Harri Okkonen, Espoo (FI); Antti Kokkinen, Espoo (FI); Ari Sinisalo, Helsinki (FI); Paulus Carpelan, Helsinki (FI); Niina Nippula, Veikkola (FI)

(73) Assignee: QUATTRO FOLIA OY, Espoo (FI)

(21) Appl. No.: 14/477,230

(22) Filed: Sep. 4, 2014

(51) Int. Cl. G06F 19/00; G06N 7/00

(52) U.S. Cl. CPC G06F 19/345; G06N 7/00

(57) ABSTRACT

A computer-implemented method for recommending an optimum insulin bolus dosage to a patient is described. The computer-implemented method includes receiving diabetes related data from the patient. The computer implemented method further includes determining a plurality of insulin bolus dosages using a plurality of insulin bolus calculators. The plurality of insulin bolus dosages are calculated based on the diabetes related data. Thereafter, an optimum insulin bolus dosage is determined based on the plurality of insulin bolus dosages. The optimum insulin bolus dosage is then presented to the patient.

### FIELD OF THE PRESENT APPLICATION

The present application generally relates to the field of diabetes management. More specifically, the present application relates to a system and method for recommending an optimum insulin bolus dosage based on a plurality of insulin bolus dosage calculations.

### BACKGROUND OF THE PRESENT APPLICATION

A patient with diabetes has a continuous challenge to estimate required insulin dosage at different instants of time. Various factors may affect the estimation of the required insulin dosage at a particular instant of time for a patient. Current blood glucose level, food eaten just before or after an insulin dosage, insulin remaining in the body from previous dosages, physical activity, stress, etc. are some of the factors that affect the estimation of the required insulin dosage at a particular instant of time. In addition, each patient reacts in a different way to each factor. Thus, the patient is required to assess how different factors contribute towards the required insulin dosage that he/she requires.

There are numerous insulin bolus calculators available that estimate an insulin dosage for the patient. The insulin dosages estimated by such insulin bolus calculators are calculated based on information provided by the patient using the insulin bolus calculators. Additionally, there are numerous insulin pumps with integrated insulin bolus calculators and glucose level monitors that are required to be calibrated periodically with blood glucose measurement. Such insulin pumps and insulin bolus calculators may work well for some patients. However, since each insulin bolus calculator uses a different algorithm to estimate an insulin bolus dosage, therefore it is difficult to determine a perfect insulin bolus calculator providing an optimum insulin dosage for a particular patient.

There is accordingly a need for an improved method and system for estimating an optimum insulin bolus dosage for a patient.

### BRIEF DESCRIPTION OF DRAWINGS

The accompanying figures wherein like reference numerals refer to identical or functionally similar elements throughout the separate views and which together with the detailed description below are incorporated in and form part of the specification, serve to further illustrate various embodiments and to explain various principles and advantages all in accordance with the present application.

FIG. 1 illustrates a system for recommending an optimum insulin bolus dosage for a patient in accordance with an embodiment of the present application.

FIG. 2 illustrates a block diagram of a computing device with one or more instructions stored on a non-transitory computer-readable medium for recommending an optimum insulin bolus dosage to a patient in accordance with an embodiment of the invention.

FIG. 3 illustrates a flow diagram of a method for recommending an optimum insulin bolus dosage for a patient in accordance with an embodiment of the present application.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present application.

### DETAILED DESCRIPTION OF THE PRESENT APPLICATION

Before describing in detail embodiments that are in accordance with the present application, it should be observed that the embodiments reside primarily in a method and system for recommending an optimum insulin bolus dosage based on a plurality of insulin bolus dosage calculations. Accordingly, the method steps and system components have been represented where appropriate by conventional symbols in the drawings, showing only those specific details that are pertinent to understanding the embodiments of the present application so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of objects may include not only those objects but also include other objects not expressly listed or inherent to such process, method, article, or apparatus. An object proceeded by “comprises . . . a” does not, without more constraints, preclude the existence of additional identical objects in the process, method, article, or apparatus that comprises the object.

Generally speaking, pursuant to various embodiments, the present application provides a method and system for recommending an optimum insulin bolus dosage. The method includes receiving diabetes related data associated with a patient at a processing unit. The diabetes related data includes, but need not be limited to, blood glucose level of the patient. Thereafter, a plurality of insulin bolus dosages is calculated using a plurality of insulin bolus calculators. The plurality of insulin bolus dosages is calculated based on the diabetes related data of the patient. Each insulin bolus dosage of the plurality of insulin bolus dosages is calculated using a corresponding insulin bolus calculator of the plurality of insulin bolus calculators. Thereafter, the optimum insulin bolus dosage is determined based on the plurality of insulin bolus dosages at the processing unit. The optimum insulin bolus dosage may be determined using one or more of, but not limited to, a weighted linear combination of the plurality of insulin bolus dosages and a selection of an insulin bolus dosage from among the plurality of insulin bolus dosages. Subsequently, the optimum insulin bolus dosage is presented to the patient.

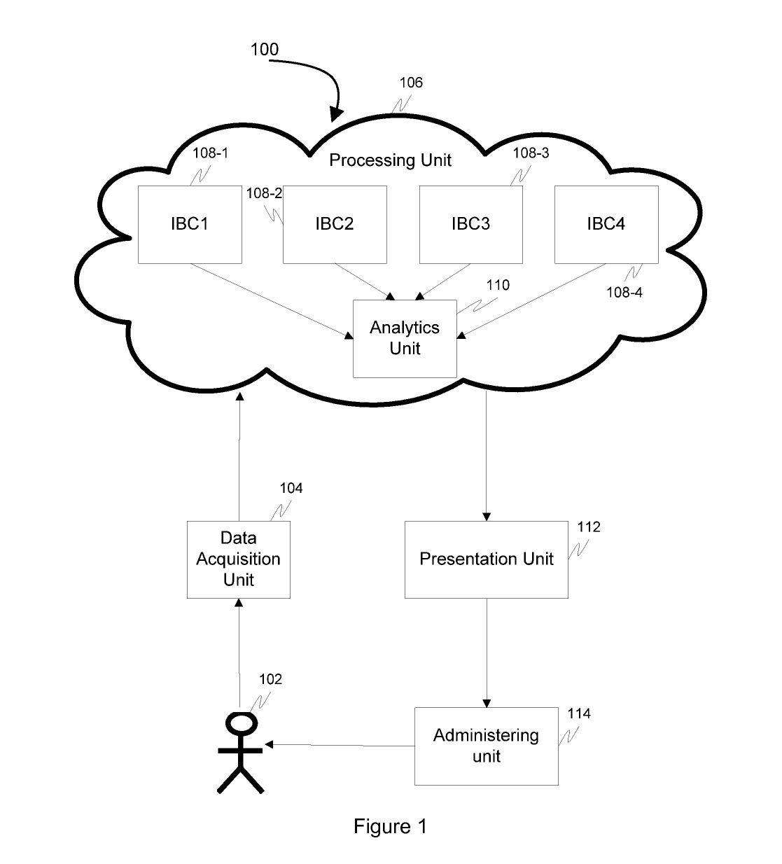

FIG. 1 illustrates a system 100 for recommending an optimum insulin bolus dosage for a patient 102 in accordance with an embodiment of the present application. As illustrated FIG. 1, system 100 includes a data acquisition unit 104 configured to obtain diabetes related data from patient 102.

Data acquisition unit 104 can be any device configured to collect obtain diabetes related data. For instance, data acquisition unit 104 can be one of, but not limited to, a mobile phone, a smartphone, a portable device, a tablet device, a laptop and a desktop computer configured to collect diabetes related data of patient 102.

Data acquisition unit 104 includes one or more sensors attached to one or more portions of the body of patient 102. The one or more sensors may include one or more of, but not limited to, a glucose sensor, a glucose meter, a step meter, an activity meter, a heart rate meter, a calorie estimator, a thermometer and a stress meter.

Data acquisition unit 104 is further configured to transmit the diabetes related data to a processing unit 106. The diabetes related data may be transmitted using one or more of, but not limited to, of a short-range wireless network, a cellular network, a wireless network and a wired network. The short range wireless network may be one or more of, but not limited to, Bluetooth network, Near Field Communication (NFC) network, Zig Bee network and Wi-Fi network. For example, data acquisition unit 104 may transmit diabetes related data to a server via internet. In another example, data acquisition unit 104 may transmit diabetes related data to a smartphone and the smartphone may transmit the diabetes related data to the server. In an embodiment, processing unit 106 is a part of a smartphone. In an embodiment, data acquisition unit 104 and processing unit 106 are part of same device. In such a scenario, the diabetes related data is transmitted locally from data acquisition unit 104 to processing unit 106.

Processing unit 106 is a processor configured to process data. In an embodiment, processing unit 106 is part of one of, but not limited to, a mobile phone, a smartphone, a portable device, a tablet device, a laptop, a desktop computer and an insulin pump. In another embodiment, processing unit 106 is hosted on a server. Processing unit 106 is configured to receive the diabetes related data from data acquisition unit 104. Processing unit 106 includes a plurality of insulin bolus calculators 108-n such as, but not limited to, an insulin bolus calculator 108-1 represented as IBC1, an insulin bolus calculator 108-2 represented as IBC2, an insulin bolus calculator 108-3 represented as IBC3 and an insulin bolus calculator 108-4 represented as IBC4. Such insulin bolus calculators may be one or more of, but not limited to, Insulin Correction Dose Calculator, Mealtime Dosage Calculator, Interactive Dosing Calculator, Insulin Initiation Dose Calculator and Insulin Pump Calculator. Each of plurality of insulin bolus calculators 108-n is configured to calculate an insulin bolus dosage based on at least some of or all the diabetes related data received from data acquisition unit 104. Thus, plurality of insulin bolus calculators 108-n can be used to obtain the plurality of insulin bolus dosages based on the diabetes related data obtained from data acquisition unit 104.

Additionally, processing unit 106 includes an analytics unit 110 configured to determine the optimum insulin bolus dosage based on the plurality of insulin bolus dosages obtained from plurality of insulin bolus calculators 108-n. A weighted linear combination may be applied on the plurality of insulin bolus dosages by analytics unit 110 to obtain the optimum insulin bolus dosage.

As illustrated in FIG. 1, system 100 also includes a presentation unit 112 for presenting the optimum insulin bolus dosage to patient 102. Presentation unit 112 may include one or more of, but not limited to, a display unit, an audio unit, a braille touch display and a haptic actuator. The optimum insulin bolus dosage may be presented in one or more of, but not limited to, a visual format, an audio format, an audiovisual format, a braille format and a haptic actuator format. Additionally, system 100 may include an administering unit 114 configured to administer the optimum insulin bolus dosage to patient 102. Administering unit 114 may include one or more of, but not limited to, an insulin pump, an insulin syringe, an insulin pen, an insulin jet injector and an insulin inhaler. In an embodiment, presentation unit 112 and administering unit 114 are part of same device.

An embodiment of the present application may relate to a computer program product with a non-transitory computer readable storage medium having computer code thereon for performing various computer-implemented operations of the method and/or system disclosed herein. The media and computer code may be those specially designed and constructed for the purposes of the method and/or system disclosed herein, or they may be of the kind well known and available to those having skill in the computer software arts. Examples of computer-readable media include, but are not limited to, magnetic media, optical media, magneto-optical media and hardware devices that are specially configured to store and execute program code. Examples of computer code include machine code, such as produced by a compiler, and files containing higher-level code that are executed by a computer using an interpreter. For example, an embodiment of the present application may be implemented using JAVA®, C++, or other object-oriented programming language and development tools. Aspects of the present application may also be implemented using Hypertext Transport Protocol (HTTP), Procedural Scripting Languages and the like.

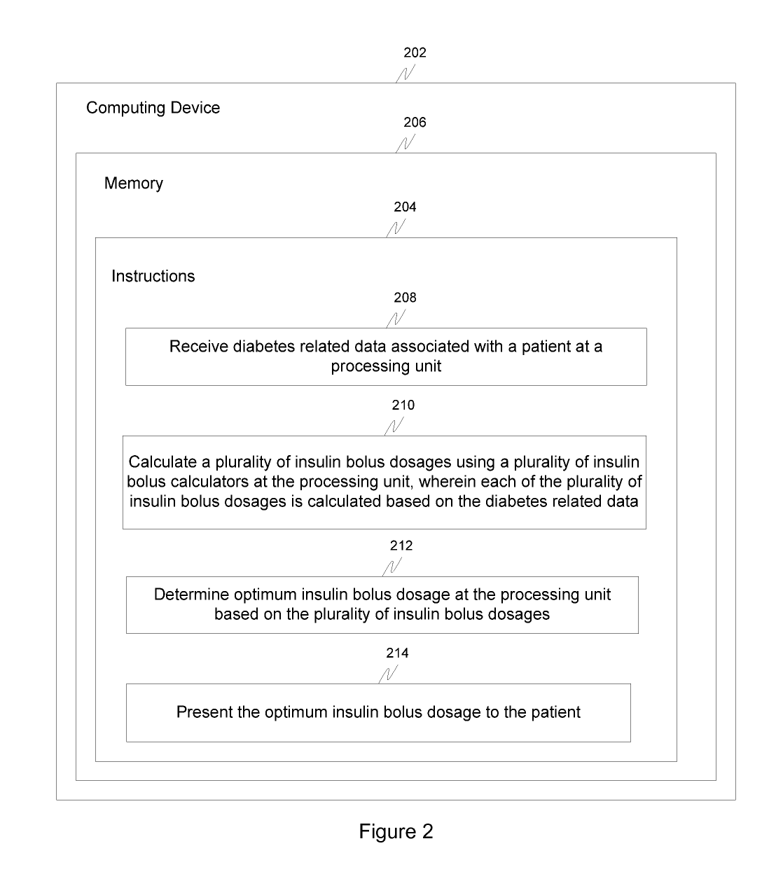

FIG. 2 illustrates a block diagram of a computing device 202 with one or more instructions 204 stored on a non-transitory computer-readable medium for recommending an optimum insulin bolus dosage to a patient in accordance with an embodiment of the invention. Computing device 202 may include according to various exemplary embodiments of the present invention one or more of, a memory 206, a processor, and an input/output device. The processor is configured to execute one or more instructions 204 stored in memory 206 of computing device 202.

As illustrated in FIG. 2, one or more instructions 204 includes an instruction 208, which can be executed to receive diabetes related data associated with a patient at computing device 202. The diabetes related data includes, but need not be limited to, blood glucose level of the patient. Similarly, instruction 210 can be executed to calculate a plurality of insulin bolus dosages using a plurality of insulin bolus calculators. The plurality of insulin bolus dosages can be calculated based on the diabetes related data. Each insulin bolus dosage of the plurality of insulin bolus dosages is calculated using a corresponding insulin bolus calculator of the plurality of insulin bolus calculators. In this, each of the plurality of insulin bolus calculators may utilize some or all of the diabetes related data for calculating an insulin bolus dosage. An optimum insulin bolus dosage may be determined by executing instruction 212. The optimum insulin bolus dosage can be determined based on the plurality of insulin bolus dosages by the processor of computing device 202. The optimum insulin bolus dosage can be presented to the patient by executing instruction 214.

The processor may be any commercially available terminal processor, or plurality of terminal processors, adapted for use in or with computing device 202 or system 100. The processor may be any suitable processor capable of executing/performing instructions. The processor may include a central processing unit (CPU) that carries out program instructions to perform the basic arithmetical, logical, and input/output operations of computing device 202 or system 100. The processor may include code (e.g., processor firmware, a protocol stack, a database management system, an operating system, or a combination thereof) that creates an execution environment for program instructions. The processor may include a programmable processor. The processor may include general and/or special purpose microprocessors.

System 100 may be a uni-processor system including one processor, or a multi-processor system including any number of suitable processors. In an embodiment, system 100 may be a smartphone or a computing device. Here, multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. System 100 may also include a computer system employing a plurality of computer systems (e.g., distributed computer systems) to implement various processing functions.

Computing device 202 includes a non-transitory memory or more than one non-transitory memories (referred to as memory 206 herein). Memory 206 may be configured, for example, to store data, including computer program product or products, which include instructions for execution on the processor. Memory 206 may include, for example, both non-volatile memory, e.g., hard disks, flash memory, optical disks, and the like, and volatile memory, e.g., SRAM, DRAM, and SDRAM as required to support embodiments of the present invention. As one skilled in the art will appreciate, though memory 206 is depicted on, e.g., a motherboard, of computing device 202, memory 206 may also be a separate component or device, e.g., flash memory, connected to computing device 202 through an input/output unit or a transceiver. As one skilled in the art will understand, the program product or products, along with one or more databases, data libraries, data tables, data fields, or other data records can be stored either in memory 206 or in separate memory (also non-transitory), for example, associated with a storage medium such as a database locally accessible to computing device 202 positioned in communication with computing device 202 through the I/O device.

Non-transitory memory further can include drivers, modules, libraries, or engines to function as a dedicated software/hardware system (i.e., a software service running on a dedicated computer) such as an application server, web server, database server, file server, home server, standalone server. For example, non-transitory memory can include a server-side markup language processor (e.g., a PHP processor) to interpret server-side markup language and generate dynamic web content (e.g., a web page document) to serve to client devices over a communications network. At the server-side, one or more server-side scripting languages can be utilized. Examples of server-side scripting languages include, but are not limited to, ASP (*.asp), ActiveVFP (*.avfp), ASP.NET (*.aspx), C (*.c, *.csp) via CGI, ColdFusion Markup Language (*.cfm), Groovy Server Pages (*.gsp), Java (*.jsp) via JavaServer Pages, JavaScript using server-side JavaScript (*.ssjs, *.js) (example: Node.js), Lua (*.lp *.op *.lua), Perl CGI (*.cgi, *.ipl, *.pl), PHP (*.php), R (*.rhtml) (example: rApache), Python (*.py) (examples: Pyramid, Flask, Django), Ruby (*.rb, *.rbw) (example: Ruby on Rails), SMX (*.smx), Lasso (*.lasso), Tcl (*.tcl), WebDNA (*.dna,*.tpl), and Progress WebSpeed (*.r,*.w).

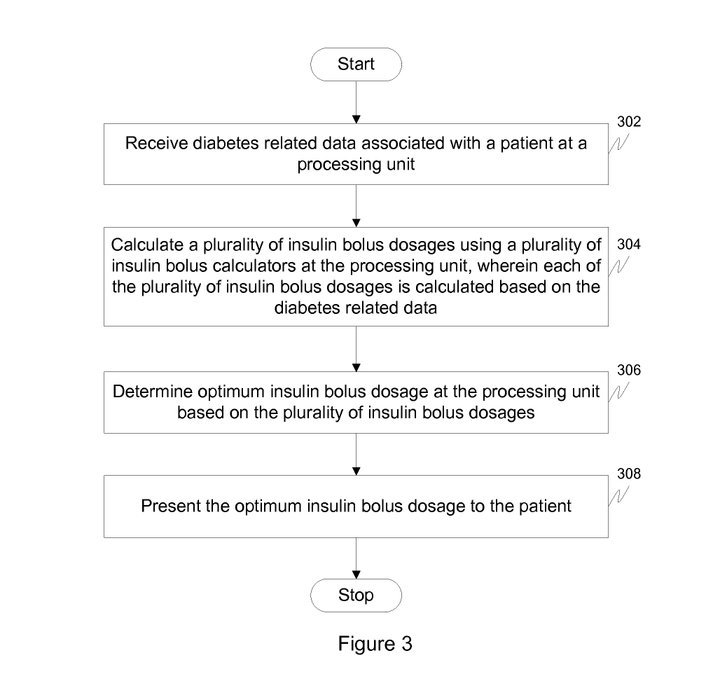

FIG. 3 illustrates a flow diagram of a method for recommending an optimum insulin bolus dosage for a patient in accordance with an embodiment of the present application. The method can be implemented by a computer such as computing device 202, system 100 or parts thereof.

At step 302, diabetes related data is obtained from a patient. The diabetes related data may include one or more of, but not limited to, blood glucose level of the patient and amount of insulin already present in the body of the patient. The diabetes related data may be obtained via data acquisition unit 104 using one or more sensors attached to one or more portions of a body of the patient. In an embodiment, the diabetes related data may be obtained using a smartphone or a computing device that is configured to measure blood glucose level of the patient. In another embodiment, diabetes related data may be entered manually by the patient.

The diabetes related data is provided to a processing unit such as processing unit 106. Additionally, statistics regarding physical health of the patient may be provided to the processing unit. Such statistics may be one or more of, but not limited to, height, weight, medical history, daily food habits and diet restrictions of the patient. Such statistics may be obtained from various sources such as, but not limited to, hospital database, doctor database, health monitoring database and data pre-filled by the patient.

Thereafter, at step 304, a plurality of insulin bolus dosages are calculated using a plurality of insulin bolus calculators such as plurality of insulin bolus calculators 108-n. Such insulin bolus calculators may be one or more of, but not limited to, Insulin Correction Dose Calculator, Mealtime Dosage Calculator, Interactive Dosing Calculator, Insulin Initiation Dose Calculator and Insulin Pump Calculator. Each of the plurality of insulin bolus calculators calculates the corresponding insulin bolus dosage using one or more of the diabetes related data and physical health of the patient. The process for calculating an insulin bolus dosage may differ for each insulin bolus calculator. For example, a process of calculating an insulin bolus dosage using IBC1 may differ from a process of calculating an insulin bolus dosage using an insulin bolus calculator IBC2.

In an embodiment, each insulin bolus calculator of plurality of insulin bolus calculators 108-n may use at least some of or all the diabetes related data to estimate an insulin bolus dosage. Optionally, additional statistics related to the patient may be used. For example, IBC1 108-1 may use diabetes related data along with a height and weight of a patient to calculate an insulin bolus dosage. Similarly, IBC2 108-2 may use only diabetes related data to calculate an insulin bolus dosage.

In an embodiment, a set of diabetes related data to obtain at step 302 is determined for each of the plurality of insulin bolus calculators, so that each of the plurality of insulin bolus calculators may work as specified. The importance of each required input data element may be linked to the performance of the corresponding each insulin bolus calculator on a particular diabetic. The ranked set of input data elements may also be indicated to the diabetic. This may assist the diabetic in ensuring that the best performing calculators get all the needed input data.

At step 306, an optimum insulin bolus dosage is determined based on the plurality of insulin bolus dosages.

In an embodiment, the optimum insulin bolus dosage is determined using a weighted linear combination of the plurality of insulin bolus dosages. The optimum insulin bolus dosage is determined using:

Iₒ=Σᵢ₌₁^{N}aᵢIᵢ.

Here, Iₒ is the optimum insulin bolus dosage, N is the number of insulin bolus calculators, aᵢ is the weight associated with a calculator i of the plurality of calculators, and Iᵢ is the insulin bolus dosage calculated using the calculator i.

It is assumed that an initial value of the weight aᵢ is denoted as 1/N. Thus, first Iₒ is an average of the proposed insulin dosages. Thereafter, the value of the weight aᵢ assigned to each calculator i is varied over a period of time based on a comparison of the measured blood glucose value and a desired blood glucose value. Thus, the value of the weight aᵢ is adaptive and varies based on proposed insulin bolus dosage of a calculator i. The value of the weight aᵢ is set higher if proposed insulin bolus dosage is closer to best/best for the patient and the value of the weight aᵢ is set lower if proposed insulin bolus dosage is not very ideal/not at all ideal for the patient. For example, an insulin bolus dosage Iₘ obtained from calculator m is compared with optimum insulin bolus dosage Iₒ. If the value of Iₘ is closer to Iₒ, then a higher weight value aₘ is assigned for calculator m. Additionally, the value differs for every period of time and/or each iteration.

The value of the weight aᵢ can also be updated using correlation. This could involve calculating a continuously updated covariance between each (Iₒ−Iᵢ) and (BG_{desired}−BGₘₑₐₛ) to update the value of weight aᵢ for a (t+1)th iteration by,

aᵢ(t+1)=aᵢ(t)+e*COV((Iₒ−Iᵢ),(BG_{desired}−BGₘₑₐₛ)).

In the above equation, e is a small positive value. The use of the above helps in increasing weights of the insulin bolus calculators that propose a higher insulin bolus dosage when the measured blood glucose is higher than desired. Similarly, the weights of the insulin bolus calculators that propose a lower insulin bolus dosage can be increased when the measured blood glucose is lower than desired.

The value of the weight aᵢ can be adjusted without requiring covariance calculations. In an embodiment, for (t+1)th iteration/period of time, the value of aᵢ is given by,

$${a}_{i} ( t + 1 ) = MAX ( 0 , ( \frac{( 2 + ( \frac{{BG}_{meas}}{{BG}_{desired}} ) )}{3} ) {a}_{i} ( t ) + e ( {I}_{o} - {I}_{i} ) ( {BG}_{desired} - {BG}_{meas} ) - 0.5 e ABS ( {I}_{o} - {I}_{i} ) ) .$$

Here, e is a small positive value, MAX is maximum value, ABS is absolute value, BGₘₑₐₛ is the amount of blood glucose measured on the patient for each insulin bolus dosage and BG_{desired} is the amount of desired blood glucose for the patient. If BGₘₑₐₛ is less than BG_{desired} and Iₒ has, thus, been too high, and Iᵢ was smaller than Iₒ, then the value of aᵢ is increased. If, on the contrary, Iᵢ was higher than Iₒ, then the value of aᵢ is decreased. The term

$$( \frac{( 2 + ( \frac{{BG}_{meas}}{{BG}_{desired}} ) )}{3} )$$

is a scaling factor configured to adjust a total insulin bolus dosage to match a required insulin bolus dosage. Additionally, term 0.5 e ABS (Iₒ−Iᵢ) is added to continuously reduce the weight of those insulin bolus calculators whose proposed insulin bolus dosage differs from optimum insulin bolus dosage. The e is included as a small positive value to maintain a stable calculation of aᵢ(t+1).

In an embodiment, at a point in time when aᵢ corresponding to all insulin bolus calculators have been updated, then new insulin bolus dosage is given by Σᵢ₌₁^{N}aᵢIᵢ. Thereafter, aᵢ(t+1) is scaled, if needed, according to the following equation:

$${a}_{i} ( t + 1 ) = min ( 1 , ( \frac{{I}_{max}}{{\sum }_{i = 1}^{N} {a}_{i} {I}_{i}} ) * {a}_{i} ( t + 1 ) ) .$$

Here, Iₘₐₓ is maximum allowed insulin bolus dosage specified for the patient. If the Σᵢ₌₁^{N}aᵢIᵢ is greater than Iₘₐₓ, then each coefficient is scaled down with a ratio that is smaller than one. This ensures that proposed insulin bolus dosage is not greater than maximum insulin bolus dosage prescribed for the patient. For example, if maximum allowed insulin bolus dosage specified for the patient is 15 units, then, at a time period t₁, weights assigned to three insulin bolus calculators IBC₁, IBC₂ and IBC₃ is a₁=0.2, a₂=0.3 and a₃=0.7, respectively. Assuming that the insulin bolus dosages proposed by the corresponding insulin bolus calculators IBC₁, IBC₂ and IBC₃ are I₁=13.5, I₂=14.5, I₃=14, respectively. An optimal insulin bolus dosage Iₒ is calculated as I₁=a₁I₁+a₂I₂+a₃I₃. The optimal insulin bolus dosage Iₒ based on the above mentioned values is 16.85. However, the maximum allowed insulin bolus dosage specified for the patient is 15. The weights are then scaled down with a ratio of

$$\frac{{I}_{max}}{{\sum }_{i = 1}^{N} {a}_{i} {I}_{i}} i . e . \frac{15}{16.85} .$$

This ensures new values of weights such as a₁=0.18, a₂=0.27 and a₃=0.62. The optimum insulin bolus dosage is now 15.

In an embodiment, if a new insulin bolus calculator is included in the system, then initial weight of the new insulin bolus calculator is denoted by,

$${a}_{N + 1} = 0.5 ( \frac{1}{( N + 1 )} ) .$$

In another embodiment, the optimum insulin bolus dosage may be determined by selecting an insulin bolus dosage from among the plurality of insulin bolus dosages. Initially, the proposed insulin bolus dosages are ranked. In the first round, the median value of the proposed insulin bolus dosages is selected for optimum bolus. If blood glucose level is too high, the insulin dosage has been too small, and in the next round one higher value than the median is selected as the optimum bolus. If the blood glucose is still too high, the next bigger bolus proposal is selected. If a difference of the measured blood glucose and the desired blood glucose is less than a predefined threshold, then the same bolus calculator is selected. If the difference is more than the predefined threshold, then another insulin bolus dosage corresponding to another insulin bolus calculator is selected. The method for selecting the optimum of the proposed insulin dosages need not be limited to the one described above and there could be numerous variations in how the optimum bolus dosage is selected.

In an embodiment, the different elements in the diabetes related data needed by each insulin bolus calculator may be weighted using the same coefficient as that of the insulin bolus calculator to create the optimum bolus. The elements of diabetes related data may then be ranked according to the weights for subsequent display to the diabetic.

The optimum insulin bolus dosage may be determined by a processing unit such as processing unit 106. The processing unit may accordingly be configured to receive diabetes related data and use the plurality of insulin bolus calculators to calculate a plurality of insulin bolus dosages. The processing unit may be included in a smartphone or a computing device. In an embodiment, the processing unit may be a server hosted on a cloud platform.

Moving on, at step 308, the optimum insulin bolus dosage is presented to the patient. The optimum insulin bolus dosage may be displayed to the patient using a presentation unit such as presentation unit 112. Alternately, the optimum insulin bolus dosage may be rendered as one of an audio message, a visual message, an audiovisual message, a braille message and a haptic actuator message to the patient. Additionally, the optimum insulin bolus dosage may be downloaded by the patient. In an embodiment, the optimum insulin bolus dosage may be presented to a medical professional attending to the patient or transmitted to a health care facility associated with the patient.

The method may include administering the optimum insulin bolus dosage to the patient using an administering unit such as administering unit 114. The presentation of the optimum insulin bolus dosage may encompass administering or visually/audibly delivering the optimum insulin bolus dosage.

The method and system disclosed herein assists a patient in determining an optimum insulin bolus dosage. The optimum insulin bolus dosage is determined based on a plurality of insulin bolus dosages calculated by a plurality of insulin bolus calculators. This assists in obtaining an optimum insulin bolus dosage that is statistically closest to the best or is the best possible value of a dosage/a combination the plurality of insulin bolus dosages. A weight assigned to each insulin bolus calculator of the plurality of insulin bolus calculators varies over a period of time. The weight varies according to an efficiency of an insulin bolus calculator. Thus, the insulin bolus calculator/calculators that match closely to a patient's requirement are used to recommend the optimum insulin bolus dosage. It may be apparent to a person skilled in the art that numerous optimization techniques may be employed to obtain an optimum insulin bolus dosage based on a plurality of insulin bolus dosages.

Those skilled in the art will realize that the above-recognized advantages and other advantages described herein are merely exemplary and are not meant to be a complete rendering of all of the advantages of the various embodiments of the present application. Additionally, embodiments need not achieve these, or another advantage, and should not be limited there to.

In the foregoing specification, specific embodiments of the present application have been described. However, one of ordinary skill in the art appreciates that various modifications and changes can be made without departing from the scope of the present application as set forth in the claims below. Accordingly, the specification and figures are to be regarded in an illustrative rather than a restrictive sense, and all such modifications are intended to be included within the scope of the present application. The benefits, advantages, solutions to problems, and any element(s) that may cause any benefit, advantage, or solution to occur or become more pronounced are not to be construed as critical, required, or essential features, of the present application.

What is claimed is:

1. A computer implemented method for recommending an optimum insulin bolus dosage to a patient, the computer implemented method comprising:
receiving a diabetes related data associated with the patient at a processing unit;
calculating a plurality of insulin bolus dosages using a plurality of insulin bolus calculators at the processing unit, wherein each of the plurality of insulin bolus dosages is calculated based on the diabetes related data;
determining the optimum insulin bolus dosage at the processing unit based on the plurality of insulin bolus dosages; and
presenting the optimum insulin bolus dosage to the patient.

2. The computer implemented method of claim 1, wherein receiving the diabetes related data associated with the patient comprises receiving a plurality of diabetes related data elements associated with the plurality of insulin bolus calculators.

3. The computer implemented method of claim 2 further comprising ranking the plurality of diabetes related data elements based on a plurality of weights associated with the plurality of insulin bolus calculators.

4. The computer implemented method of claim 1, wherein the optimum insulin bolus dosage is determined using,
$${I}_{o} = {\sum }_{i = 1}^{N} {a}_{i} {I}_{i}$$
wherein, Iₒ is the optimum insulin bolus dosage, N is the number of insulin bolus calculators, aᵢ is the weight associated with a calculator i of the plurality of calculators, and Iᵢ is the insulin bolus dosage calculated using the calculator i.

5. The computer implemented method of claim 4, wherein a value of aᵢ is adapted over a period of time based on an association between Iᵢ and Iₒ, wherein the association is determined based on a variance of blood glucose level of the patient over the period of time.

6. The computer implemented method of claim 4, wherein an initial value of aᵢ is 1/N.

7. The computer implemented method of claim 6, wherein a value of aᵢ at (t+1)th iteration is given by
$${a}_{i} ( t + 1 ) = MAX ( 0 , ( \frac{( 2 + ( \frac{{BG}_{meas}}{{BG}_{desired}} ) )}{3} ) {a}_{i} ( t ) + e ( {I}_{o} - {I}_{i} ) ( {BG}_{desired} - {BG}_{meas} ) - 0.5 e ABS ( {I}_{o} - {I}_{i} ) )$$
wherein e is a positive value, BGₘₑₐₛ is the amount of blood glucose measured on the patient for each insulin bolus dosage and BG_{desired} is the amount of desired blood glucose for the patient.

8. The computer implemented method of claim 7, wherein the term
$$( \frac{( 2 + ( \frac{{BG}_{meas}}{{BG}_{desired}} ) )}{3} )$$
is a scaling factor configured to adjust a total insulin bolus dosage to match a required insulin bolus dosage.

9. The computer implemented method of claim 7, wherein aᵢ(t+1) is scaled using:
$${a}_{i} ( t + 1 ) = min ( 1 , ( \frac{{I}_{max}}{{\sum }_{i = 1}^{N} {a}_{i} {I}_{i}} ) * {a}_{i} ( t + 1 ) )$$
wherein, Iₘₐₓ is a maximum insulin bolus dosage specified for the patient.

10. The computer implemented method of claim 4 further comprising utilizing a new insulin bolus calculator wherein a weight of the new insulin bolus calculator is given by,
$${a}_{N + 1} = 0.5 ( \frac{1}{( N + 1 )} ) .$$

11. The computer implemented method of claim 1, wherein determining the optimum insulin bolus dosage comprises selecting an insulin bolus dosage from among the plurality of insulin bolus dosages.

12. The computer implemented method of claim 1, wherein the presenting the optimum insulin bolus dosage comprises rendering the optimum insulin bolus dosage as one of an audio message, a visual message, an audiovisual message, a braille message and a haptic actuator message to the patient.

13. The computer implemented method of claim 1 further comprising transmitting the optimum insulin bolus dosage to an administering unit configured to administer the optimum insulin bolus dosage to the patient.

14. A system for recommending an optimum insulin bolus dosage to a patient, the system comprising:
a data acquisition unit configured to:
obtain a diabetes related data from the patient; and
transmit the diabetes related data to a processing unit;
the processing unit configured to receive the diabetes related data from the data acquisition unit, the processing unit comprising:
a plurality of insulin bolus calculators configured to calculate a plurality of insulin bolus dosages, wherein each of the plurality of insulin bolus calculators calculates the insulin bolus dosage based on the diabetes related data; and
an analytics unit configured to determine the optimum insulin bolus dosage based on the plurality of insulin bolus dosages obtained from the plurality of insulin bolus calculators; and
a presentation unit configured to present the optimum insulin bolus dosage to the patient.

15. The system of claim 14, wherein the processing unit is hosted on a server.

16. The system of claim 14, wherein the data acquisition unit is further configured to transmit the diabetes related data to the processing unit via at least one of a short-range wireless network, a cellular network, a wireless network and a wired network.

17. The system of claim 14, wherein the data acquisition unit comprises at least one of a step meter, an activity meter, a heart rate meter, a calorie estimator, a thermometer and a stress meter.

18. The system of claim 14 further comprising an administering unit configured to administer the optimum insulin bolus dosage to the patient.

19. The system of claim 14, wherein the presentation unit is further configured to present the optimum insulin bolus dosage in at least one of a visual format, an audio format, an audiovisual format, a braille format and a haptic actuator format.

20. A non-transitory computer readable medium storing a computer program for causing a computing device to perform a method of recommending an optimum insulin bolus dosage to a patient, the method comprising:
receiving a diabetes related data associated with the patient at a processing unit;
calculating a plurality of insulin bolus dosages using a plurality of insulin bolus calculators at the processing unit, wherein each of the plurality of insulin bolus dosages is calculated based on the diabetes related data;
determining the optimum insulin bolus dosage at the processing unit based on the plurality of insulin bolus dosages; and
presenting the optimum insulin bolus dosage to the patient.
